(19) United States
(12) Patent Application Publication
(10) Pub. No.: US 2014/0315591 A1
(43) Pub. Date: Oct. 23, 2014

(54) COMMUNICATION TERMINAL DEVICE, COMMUNICATION SYSTEM, AND METHOD OF CONTROLLING COMMUNICATION TERMINAL DEVICE

(71) Applicant: Panasonic Corporation, Osaka (JP)

(72) Inventors: Yosuke Ukita, Osaka (JP); Toshio Taniguchi, Kyoto (JP); Takashi Fujii, Hyogo (JP); Teruhito Takeda, Hyogo (JP); Seiji Nimura, Hyogo (JP); Satoshi Okage, Osaka (JP)

(21) Appl. No.: 14/355,059

(22) PCT Filed: Aug. 29, 2013
(86) PCT No.: PCT/JP2013/005108

§ 371 Date: Apr. 29, 2014

(30) Foreign Application Priority Data
Sep. 7, 2012 (JP) 2012-197442

(51) Int. Cl. H04W 60/00; H04W 48/10; H04W 72/04

(52) U.S. Cl. CPC H04W 60/00; H04W 72/0406; H04W 48/10; H04W 72/0453
USPC 455/510

(57) ABSTRACT

A communication terminal device includes the following units. A detection unit detects a control signal instructing start of registration processing. A channel selection unit selects at random, from a plurality of frequency channels, the first frequency channel to be used in transmission of a beacon request when the control signal is detected. A scan control unit transmits the beacon request to the control devices by using the selected frequency channel. A receiving unit receives the beacon signal transmitted from each of the control devices. A list storage unit stores a predetermined parameter included in the beacon signal and the frequency channel in association with each other. A registration control unit transmits a registration request signal to the control device.

### TECHNICAL FIELD

The present invention relates to a communication terminal device and a method of controlling the communication terminal device for registering, as a target to be controlled, the communication terminal device into a control device.

### BACKGROUND ART

In a network 30 as illustrated in FIG. 1 which includes a parent wireless communication device (hereinafter, referred to as a “control device”) and a plurality of child wireless communication devices (hereinafter, referred to as “communication terminal devices”), it is necessary to perform implementation registration for registering the communication terminal devices 10a, 10b, . . . , 10n into the control device 20 before first using them.

As illustrated in FIG. 2, in order to register the communication terminal device 10 into the control device 20, the implementation registration (hereinafter, referred to also simply as “registration”) includes: scanning (Step S10) performed by the communication terminal device 10 to search for the control device 20; association (Step S20) performed by then the communication terminal device 10 to request the searched-out control device 20 to register the communication terminal device 10; and authentication (Step S30) performed by the control device 20 to authenticate the communication terminal device 10.

In the scanning, it is necessary for the communication terminal device to search a plurality of control devices including control devices in nearby networks in neighbors and the like for a desired control device to be connected (a control device at home, or a home control device).

Therefore, for example, according to Institute of Electrical and Electronics Engineers (IEEE) 802.15.4, the communication terminal device broadcast-transmits (simultaneously transmits) a beacon request (referred to also as a “beacon request”) to a plurality of control devices, and each control device which receives the beacon request transmits a beacon (referred to also as a “beacon signal”) back to the communication terminal device. The communication terminal device receives such beacons from the control devices, and stores the beacons in a receiving buffer.

Subsequently, in the association (Step S20 in FIG. 2), the communication terminal device transmits a registration request (for example, association request) to a desired control device among the control devices which have transmitted the beacons. When the registration request is received from the communication terminal device, the control device determines whether or not to be connected to the communication terminal device, and transmits back to the communication terminal device a registration response (association response) added with information indicating connection permission or connection rejection.

If the registration response indicates connection permission and the association thereby has been completed, then, the authentication (Step S30 in FIG. 2) such as authentication of key information is performed between the control device and the communication terminal device, thereby completing the implementation registration.

On the other hand, if the registration response indicates connection rejection, the communication terminal device determines that the control device is not the desired control device and transmits a connection request sequentially to the other control devices which have transmitted the remaining beacons stored in the receiving buffer.

There is disclosed a technique by which, in a network as described above, the desired control device (home control device) only transmits a beacon twice in response to a beacon request of the communication terminal device, and the communication terminal device determines the control device as the home control device when receiving the second beacon (for example, see Patent Literature (PTL) 1).

Furthermore, there is disclosed another technique by which the control device transmits a beacon added with option information such as “connection permission or rejection” or the like, and the communication terminal device determines the control device as the home control device by analyzing the beacon (for example, see Patent Literature (PTL) 2),

### CITATION LIST

### Patent Literature

[PTL 1] Japanese Patent No. 4316488
[PTL 2] Japanese Unexamined Patent Application Publication No. 2006-19962

### SUMMARY OF INVENTION

### Technical Problem

However, the conventional techniques have a problem that, if, for example, there are a large number of control devices in neighboring networks, a large number of receiving buffers (memories) are necessary in the communication terminal device to receive beacons from all the control devices.

In order to address the problem, the present invention provides a communication terminal device and the like each capable, for each implementation registration of the communication terminal device, of increasing a probability of efficiently finding a desired control device and causing the desired control device to register the communication terminal device, thereby increasing a success rate of the implementation registration even with a small memory capacity.

### Solution to Problem

In accordance with an aspect of the present invention for achieving the object, there is provided a communication terminal device including: a wireless communication unit configured to wirelessly communicate with control devices; a detection unit configured to detect a control signal instructing start of registration processing for causing a desired control device among the control devices to register the communication terminal device as a target to be controlled; a channel selection unit configured to sequentially select, from a plurality of frequency channels, a frequency channel to be used in transmission of a beacon request for requesting each of the control devices to transmit a beacon signal; a first transmission control unit configured to transmit, via the wireless communication unit, the beacon request to the control devices by using the frequency channel selected by the channel selection unit; and a receiving unit configured to receive, via the wireless communication unit, the beacon signal transmitted from each of the control devices in response to the beacon request, wherein the channel selection unit is configured to select at random a first frequency channel to be used in transmission of the beacon request from the frequency channels, when the detection unit detects the control signal.

These general and specific aspects may be implemented as a system, a method, an integrated circuit, a computer program, and a computer-readable recording medium, such as a Compact Disc-Read Only Memory (CD-ROM), and may be implemented also as a desired combination of them.

### Advantageous Effects of Invention

According to the above aspect, it is possible to increase a probability of registering a communication terminal device to a desired control device every time implementation registration is performed. Furthermore, it is possible to find the desired control device in a short time, thereby reducing a time required for the implementation registration.

### BRIEF DESCRIPTION OF DRAWINGS

FIG. 1 is a schematic diagram illustrating an example of a configuration of a network.

FIG. 2 is a schematic diagram of a flow of registering, as a target to be controlled, a communication terminal device into a control device.

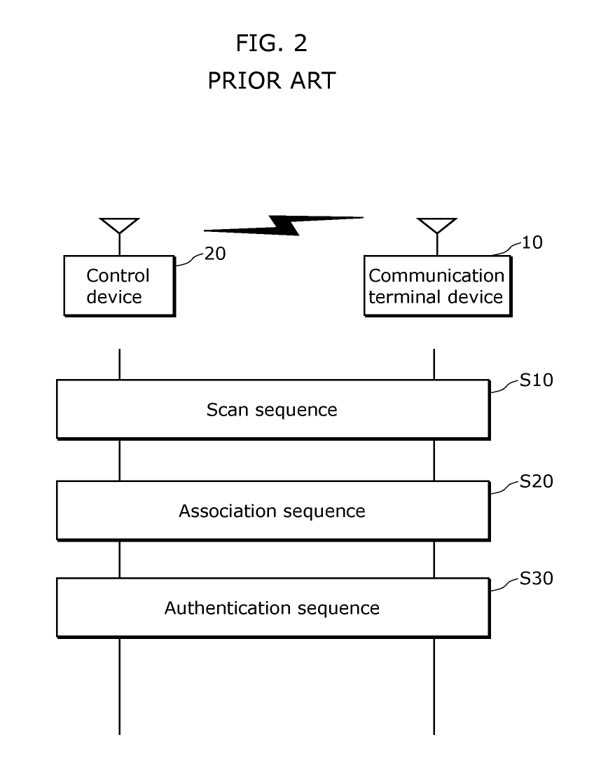

FIG. 3 is a sequence diagram of an example of scanning performed by the communication terminal device.

FIG. 4 is a block diagram illustrating a structure of a communication terminal device according to Embodiment 1.

FIG. 5 is a diagram of an example of a control device list stored in a list storage unit in the communication terminal device.

FIG. 6 is a flowchart of scanning performed by the communication terminal device according to Embodiment 1.

FIG. 7 is a sequence diagram of an example of detailed steps in the scanning according to Embodiment 1.

FIG. 8 is a block diagram illustrating a structure of a communication terminal device according to Embodiment 2.

FIG. 9 is a flowchart of scanning performed by the communication terminal device according to Embodiment 2.

FIG. 10 is a sequence diagram of an example of detailed steps in the scanning according to Embodiment 2.

FIG. 11 is a block diagram illustrating a structure of a communication terminal device according to Embodiment 3.

FIG. 12 is a flowchart of scanning performed by the communication terminal device according to Embodiment 3.

FIG. 13 is a sequence diagram of an example of detailed steps in the scanning according to Embodiment 3.

### DESCRIPTION OF EMBODIMENTS

(Observation Based on which Present Invention is Conceived)

The inventors of the present invention found the following problems in the communication terminal devices disclosed in “Background Art”.

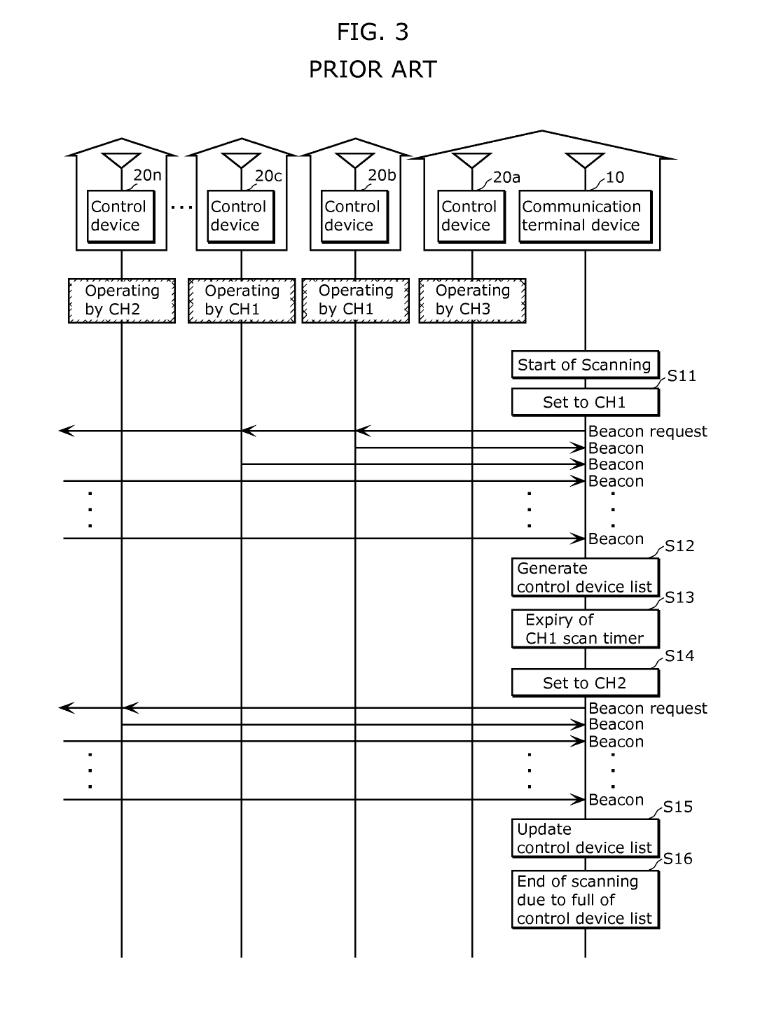

FIG. 3 is a sequence diagram of an example of scanning performed by a communication terminal device.

In general, between a communication terminal device 10 and control devices 20 (20a, 20b, 20c, . . . 20n), communication is performed by selecting a single frequency channel from a plurality of frequency channels (hereinafter, referred to also simply as “channels”).

When the communication terminal device 10 broadcast-transmits a beacon request to scan control devices 20, the communication terminal device 10 sets a channel 1 (CH1) for the transmission of the beacon request (Step S11). Then, the communication terminal device 10 first broadcast-transmits the beacon request by the channel 1. In response to the beacon request, control devices 20 operating by the channel 1 transmit their beacons to the communication terminal device 10 by the channel 1.

When receiving the beacons by the channel 1, the communication terminal device 10 generates a control device list in which a network ID, an address, and the like included in a corresponding beacon are stored for each of the control devices 20 (Step S12). When a predetermined scan time period has passed (expiry of a scan timer), the communication terminal device 10 ends the scanning by the channel 1 (Step S13).

Next, the communication terminal device 10 sets a channel 2 (CH2) for transmitting a beacon request (Step S14). Then, the communication terminal device 10 broadcast-transmits the beacon request by the channel 2 in the same manner as described above. In response to the beacon request, a control device 20 operating by the channel 2 transmits a beacon to the communication terminal device 10 by the channel 2. In the same manner as described above, when receiving the beacon by the channel 2, the communication terminal device 10 adds a network ID, a device address, and the like included in the received beacon of the control device 20 to the control device list, thereby updating the control device list (Step S15). Here, if the control device list is full (in other words, the receiving buffer is full), then the communication terminal device 10 ends the scanning (Step S16).

Here, for example, a network ID is a Personal Area Network (PAN) ID, a Service Set ID (SSID), or the like.

The device address is, for example, a Media Access Control (MAC) address, a 64-bit Extended Address, a 16-bit short address, or the like.

If the control device list includes a control device 20 in user's home (control device 20a in FIG. 3), the communication terminal device 10 transmits a registration request to the control device 20. Here, it is possible to determine whether or not the control device list includes the home control device 20 in the following way. For example, a beacon including a parameter indicating that a registration button or the like is pressed to make the control device 20 ready for registration is transmitted, and then it is determined whether or not the control device list includes the control device 20 corresponding to the beacon including the parameter.

Furthermore, even if it is impossible to determine whether or not the control device list includes the home control device 20 (20a in FIG. 3), the communication terminal device 10 can made the determination by transmitting a registration request sequentially to the control devices in the control device list and receiving a registration response added with information indicating connection permission or connection rejection from each of the control devices. In this case, if a registration button or the like of the control device 20 is pressed to make the control device 20 ready for registration, the control device 20 sends back a registration response indicating connection permission.

On the other hand, if the control device list includes the home control device 20, the communication terminal device 10 broadcast-transmits again a beacon request for scanning control devices 20. However, even in the re-scanning, the communication terminal device 10 sets the channel 1 used in the first scanning for re-transmitting the beacon request.

Moreover, in wireless communication using a frequency band of, for example, 400 MHz to 920 MHz, which is a radio frequency band lower than 2.4 GHz band, a propagation distance of radio waves is long and a propagation area sometimes has a radius of 100 m or more even in a residential area. Therefore, if there are a large number of control devices in nearby networks (neighbors), it is assumed that beacons are received from one hundred or more control devices.

In such a case, the control device list becomes full (the receiving buffer becomes full) before scanning has been performed by all the channels, and thereby the scanning is terminated before completion. Therefore, if the control device list does not include the home control device when the scanning is terminated before completion, re-scanning starts using the channel 1 like the first scanning as described previously. Therefore, however long scanning is performed, it is impossible to find the home control device. In order to solve the above problem, the communication terminal device is required to have a receiving buffer having a capacity large enough to receive beacons from one hundred or more control devices, in other words, a large-capacity memory.

In accordance with an aspect of the present invention for achieving the object, there is provided a communication terminal device including: a wireless communication unit configured to wirelessly communicate with control devices; a detection unit configured to detect a control signal instructing start of registration processing for causing a desired control device among the control devices to register the communication terminal device as a target to be controlled; a channel selection unit configured to sequentially select, from a plurality of frequency channels, a frequency channel to be used in transmission of a beacon request for requesting each of the control devices to transmit a beacon signal; a first transmission control unit configured to transmit, via the wireless communication unit, the beacon request to the control devices by using the frequency channel selected by the channel selection unit; and a receiving unit configured to receive, via the wireless communication unit, the beacon signal transmitted from each of the control devices in response to the beacon request, wherein the channel selection unit is configured to select at random a first frequency channel to be used in transmission of the beacon request from the frequency channels, when the detection unit detects the control signal

With the above structure, even if there are a large number of control devices in neighboring networks and a large number of beacons are received, the communication terminal device is capable, without a large-capacity memory, of finding out the home control device and causing the home control device to register the communication terminal device as a target to be controlled. Furthermore, even if, for example, the first attempt for registration processing fails to find the home control device, it is possible to increase a probability of finding the home control device and causing the home control device to register the communication terminal device as the number of attempts for the registration processing is increased.

It is also possible that the communication terminal device further includes: a first storage unit configured to store (a) a predetermined parameter included in the beacon signal received by the receiving unit and (b) the frequency channel selected by the channel selection unit in association with each other; and a second transmission control unit configured to transmit a registration request to the desired control device specified by the predetermined parameter by the frequency channel associated with the predetermined parameter, the registration request being for requesting the desired control device to register the communication terminal device as the target to be controlled, wherein the receiving unit is configured to further receive a registration response signal transmitted from the desired control device in response to the registration request, the registration response signal indicating that the desired control device has completed the registration of the communication terminal device or that the desired control device rejects the registration.

With the above structure, the communication terminal device is capable of checking completion of the registration of the communication terminal device into the control device. As a result, the registration is surely completed.

It is further possible that the channel selection unit is configured to select at random a first frequency channel to be used in re-transmission of the beacon request, when the detection unit re-detects the control signal.

With the above structure, even if, for example, the first attempt for registration processing fails to find the home control device, the communication terminal device can increase a probability of finding the home control device and causing the home control device to register the communication terminal device as the number of attempts for the registration processing is increased.

It is still further possible that the communication terminal device further includes a second storage unit configured to store information indicating a frequency channel that is currently used to transmit the beacon request, wherein the channel selection unit is configured to, when the detection unit re-detects the control signal, determine, as a first frequency channel to be used in re-transmission of the beacon request, one of (a) the frequency channel stored in the second storage unit and (b) a subsequent frequency channel.

With the above structure, even if, for example, the first attempt for registration processing fails to find the home control device, the communication terminal device can increase a probability of finding the home control device and causing the home control device to register the communication terminal device as the number of attempts for the registration processing is increased.

It is still further possible that the communication terminal device further includes a sensor unit configured to detect a receiving electrical field intensity of the beacon signal received by the receiving unit, wherein the first storage unit is configured to, for each of the control devices, store the receiving electrical field intensity detected by the sensor unit in addition to the predetermined parameter and the frequency channel in association with one another, and the second transmission control unit is configured to transmit the registration request to the desired control device specified by the predetermined parameter in a group including a highest receiving electrical field intensity among at least one group in which the predetermined parameter, the frequency channel, and the receiving electrical field intensity are associated with one another in the first storage unit.

Thereby, even if, for example, a beacon does not include information for determining whether or not a corresponding control device is the home control device, it is possible to cause the home control device to register the communication terminal device as a target to be controlled.

It is still further possible that the communication terminal device further includes a transmission power control unit configured to lower a transmission power level from a predetermined transmission power level, when the first transmission control unit is to transmit the beacon request.

Therefore, a propagation area of the beacon request signal is reduced. As a result, even if there are a large number of control devices in neighboring networks in an original propagation area of the beacon request signal, it is possible, without a large-capacity memory, to find out the home control device and cause the home control device to register the communication terminal device as a target to be controlled.

It is still further possible that the transmission power control unit is configured to, when the first transmission control unit completes the transmission of the beacon request, set the transmission power level lowered for the transmission of the beacon request back to the predetermined transmission power level.

With the above structure, it is possible to set the transmission power level back to the predetermined transmission power level to transmit signals except the beacon request signal.

It is still further possible that wherein the communication terminal device is one of a home appliance and an energy-related device each of which has a communication function.

Here, the communication terminal device is, for example, a home appliance such as a refrigerator, a microwave, a washing machine, or an air conditioner, or an energy-related device such as a distribution board, a power meter, a gas meter, a solar panel, a heat pump, a storage battery, or a fuel battery.

It is still further possible that the beacon signal is a beacon frame compliant with IEEE802.15.4 standard, and the beacon request is a beacon request frame compliant with the IEEE802.15.4 standard.

It is still further possible that the beacon signal is a probe response frame compliant with IEEE802.11 standard, and the beacon request is a probe request frame compliant with the IEEE802.11 standard.

These general and specific aspects may be implemented as a system, a method, an integrated circuit, a computer program, and a computer-readable recording medium, such as a Compact Disc-Read Only Memory (CD-ROM), and may be implemented also as a desired combination of them.

Hereinafter, certain exemplary embodiments are described with reference to the accompanying Drawings.

It should be noted that all the embodiments described below are specific examples of the present invention. Numerical values, shapes, materials, constituent elements, arrangement positions and the connection configuration of the constituent elements, steps, the order of the steps, and the like described in the following embodiments are merely examples, and are not intended to limit the present invention. Therefore, among the constituent elements in the following embodiments, constituent elements that are not described in independent claims that show the most generic concept of the present invention are described as elements constituting more desirable configurations.

### Embodiment 1

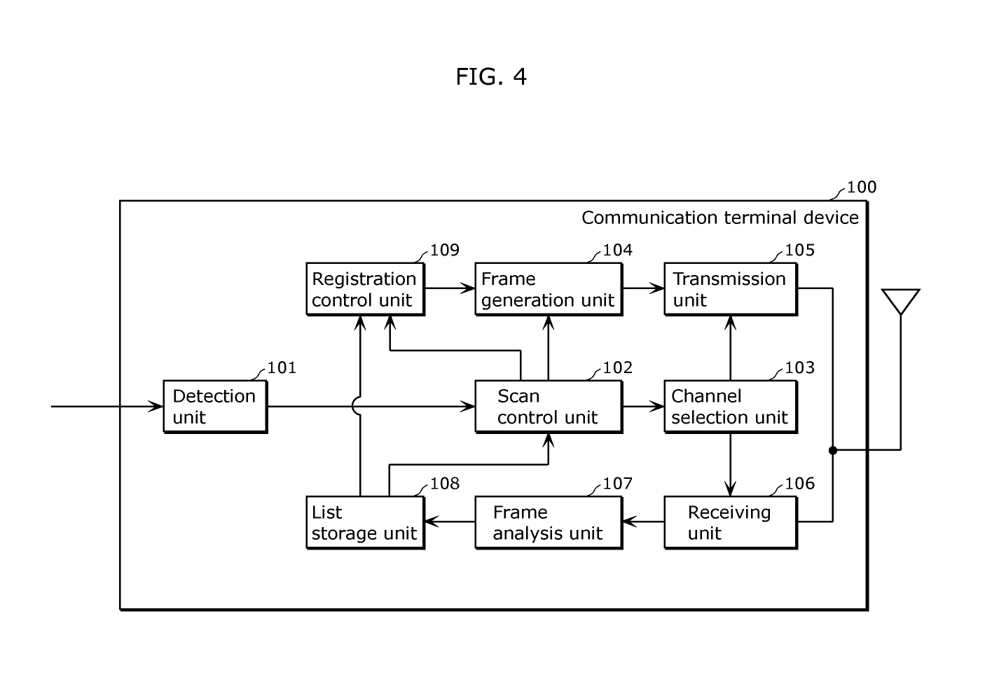

FIG. 4 is a block diagram illustrating a structure of a communication terminal device according to Embodiment 1.

The communication terminal device 100 is a device that causes a control device to register the communication terminal device 100 as a target to be controlled. As illustrated in FIG. 4, the communication terminal device 100 includes a detection unit 101, a scan control unit 102, a channel selection unit 103, a frame generation unit 104, a transmission unit 105, a receiving unit 106, a frame analysis unit 107, a list storage unit 108, and a registration control unit 109.

Here, the communication terminal device 100 is, for example, a home appliance such as a refrigerator, a microwave, a washing machine, or an air conditioner, or an energy-related device such as a distribution board, a power meter, a gas meter, a solar panel, a heat pump, a storage battery, or a fuel battery. The communication terminal device 100 may be attached to the home appliance or the energy-related device.

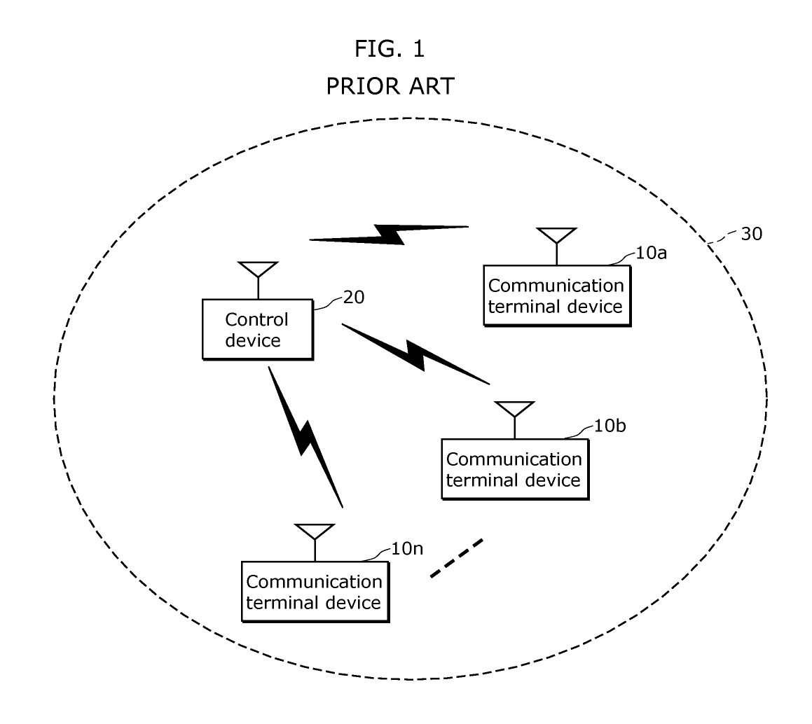

The communication terminal device 100 is used in, for example, the same network configuration as illustrated in FIG. 1.

If the communication terminal device 100 is a new target to be controlled, the detection unit 101 in the communication terminal device 100 detects a control signal instructing start of registration processing for registering the communication terminal device 100 to a control device at home (home control device), and notifies the control signal to the scan control unit 102. This control signal instructing start of registration processing is issued by a user operation on the communication terminal device 100, such as pressing a registration button or the like, connection to an electrical outlet, pressing a power button, or the like.

The scan control unit 102 performs scanning to search for the home control device. More specifically, the scan control unit 102 performs control to broadcast-transmit, to control devices, a beacon request signal (hereinafter, referred to also simply as a “beacon request”) for requesting transmission of a beacon signal (hereinafter, referred to also simply as a “beacon”). The scanning allows the terminal device to search a plurality of control devices including control devices in nearby networks such as networks in neighbors, for a desired control device to be connected (home control device).

Furthermore, the scan control unit 102 performs control to broadcast-transmit a beacon request by all of a plurality of frequency channels. Under the control, a beacon request is broadcast-transmitted (simultaneously transmitted) first by using one of the frequency channels. Here, when a predetermined scan time period has passed (expiry of a scan timer), the scan control unit 102 ends the scanning by the current frequency channel and starts broadcast-transmission of a beacon request by using a different frequency channel.

When the detection unit 101 detects such a control signal, the channel selection unit 103 selects one of the frequency channels at random as the first frequency channel to be used in beacon request transmission. When the scanning by the current frequency channel is completed, the channel selection unit 103 then selects a subsequent frequency channel (for example, selects a channel 4 if the current frequency channel is a channel 3). In this manner, the channel selection unit 103 selects the channels sequentially one by one.

The frame generation unit 104 generates a frame of a beacon request according to instructions from the scan control unit 102.

The transmission unit 105 is a part of the wireless communication unit according to the aspect of the present invention. The transmission unit 105 uses a frequency channel selected by the channel selection unit 103 to broadcast-transmit the frame of the beacon request which has been generated by the frame generation unit 104.

The receiving unit 106 is also a part of the wireless communication unit according to the aspect of the present invention. The receiving unit 106 receives beacons transmitted from a plurality of control devices operating by using the same frequency channel as selected by the channel selection unit 103 in response to the beacon request.

The frame analysis unit 107 analyzes the beacons received by the receiving unit 106. From each of the beacons, the frame analysis unit 107 retrieves a predetermined parameter, such as a network ID and a device address which are used for identifying the control device of the beacon. Then, the frame analysis unit 107 stores such parameters into the list storage unit 108 in association with the frequency channel.

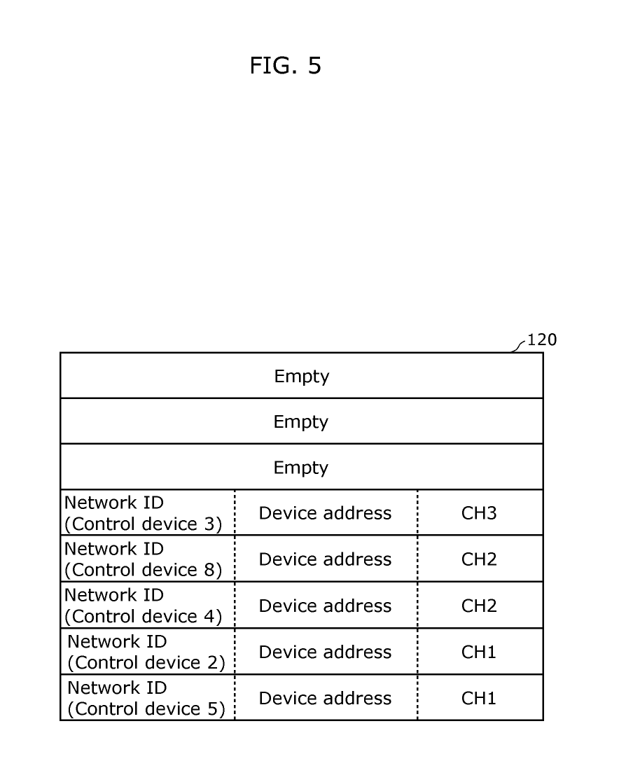

The list storage unit 108 is implemented to a memory or the like, and an example of the first storage unit according to the aspect of the present invention. For example, as illustrated in FIG. 5, the list storage unit 108 stores the network ID and the device address regarding each of the control devices in association with the frequency channel as a control device list.

The registration control unit 109 requests a searched-out desired control device 20 among the control devices to register the communication terminal device 10, when the scan control unit 102 has completed the scanning by using all of the frequency channels. The registration control unit 109 transmits a registration request to the desired control device in the control device list stored in the list storage unit 108, so as to request the desired control device to register the communication terminal device 100 as a target to be controlled. Here, by using the network ID and the device address stored in the control device list, the registration control unit 109 transmits a registration request to the desired control device by the corresponding frequency channel, namely, the frequency channel used by the desired control device in transmitting the received beacon.

The communication terminal device 100 determines whether or not the control device list includes the home control device, for example, by receiving, from a control device, a beacon including a parameter indicating that the control device is ready for registration by pressing of a registration button or the like, and determining whether or not the control device list includes the control device corresponding to the beacon including the parameter.

It is also possible that the communication terminal device transmits a registration request sequentially to the control devices indicated in the control device list, and receiving, from each of the control devices, a registration response added with information indicating connection permission or connection rejection, thereby making the above determination. In this case, if a registration button or the like of the control device is pressed and the control device is thereby ready for performing registration, the control device sends a registration response indicating connection permission back to the communication terminal device. The determination is made not only by the above-described methods, but may be made by other methods.

Next, processing performed by the communication terminal device 100 having the above-described structure is described.

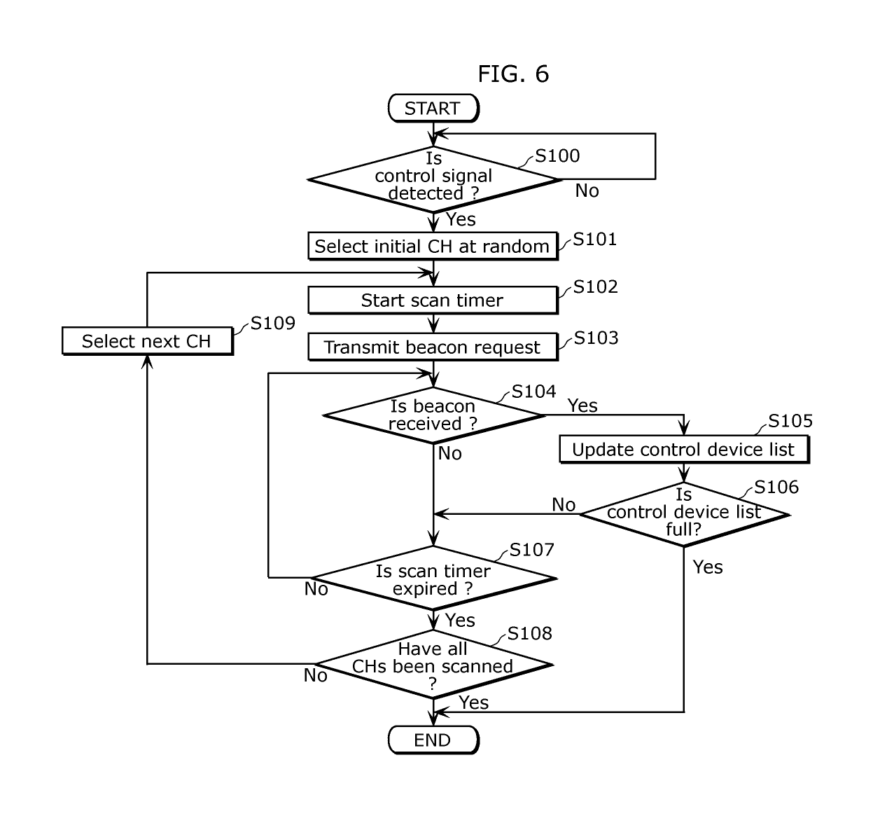

FIG. 6 is a flowchart of the scanning performed by the communication terminal device 100 according to Embodiment 1.

When the detection unit 101 detects a control signal instructing start of registration processing (Yes at Step S100), the channel selection unit 103 selects the first frequency channel to be used in transmission of a beacon request from among a plurality of frequency channels at random (Step S101). The scan control unit 102 starts a scan timer for which a scan time period is previously set (Step S102). The scan control unit 102 performs control to broadcast-transmit a beacon request (Step S103). More specifically, the scan control unit 102 instructs the frame generation unit 104 and the transmission unit 105 to broadcast-transmit a beacon request by using the frequency channel selected by the channel selection unit 103.

The scan control unit 102 determines whether or not the receiving unit 106 receives a beacon (Step S104). If it is determined that a beacon is received (Yes at Step S104), then the frame analysis unit 107 analyzes the beacon received by the receiving unit 106, then retrieves, from the beacon, a predetermined parameter, such as a network ID and a device address which are used for identifying the control device having transmitted the beacon, and stores the network ID and the device address into the list storage unit 108 in association with the frequency channel as the control device list (updates the control device list) (Step S105).

Next, the scan control unit 102 determines whether or not the control device list stored in the list storage unit 108 is full (Step S106). If it is determined that the control device list is full (Yes at Step S106), then the scan control unit 102 ends the scanning.

On the other hand, if the control device list is not full (No at Step S106) and if any beacon is not received (No at Step S104), then the scan control unit 102 determines whether or not the scan timer is expired (the predetermined scan time period has passed) (Step S107).

If it is determined that the scan timer is not expired (No at Step S107), then the processing returns to the step for the beacon receipt determination (Step S104). On the other hand, if the scan timer is expired (Yes at Step S107), then the scan control unit 102 determines whether or not scanning has been performed by using all the frequency channels (Step S108).

If it is determined that scanning has not yet been performed by using all the frequency channels (No at Step S108), then the channel selection unit 103 selects a subsequent frequency channel (for example, selects a channel 4 if the current frequency channel is a channel 3) (Step S109) and the processing returns to the step for the scan timer start (Step S102) and repeats the subsequent steps. If scanning has already been performed by using all the frequency channels (Yes at Step S108), then the scan control unit 102 ends the scanning.

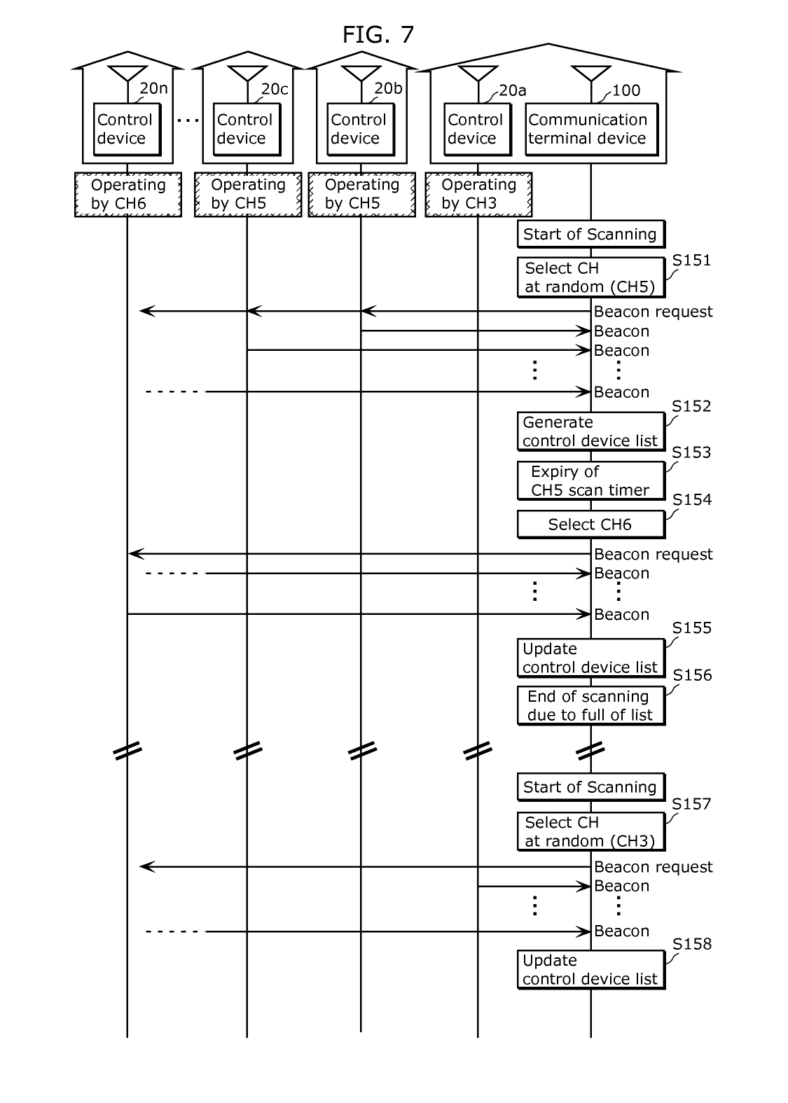

FIG. 7 is a sequence diagram of an example of detailed steps in the scanning according to Embodiment 1. It should be noted that, for the sake of simplicity in the explanation, the sequence diagram of FIG. 7 does not include all of the steps in the flowchart of FIG. 6.

Referring to FIG. 7, when the detection unit 101 detects a control signal instructing start of registration processing, scanning starts. Then, the channel selection unit 103 selects one of the frequency channels at random as the first frequency channel to be used in transmission of a beacon request. In this example, a channel 5 (CH5) is selected (Step S151). In this state, the transmission unit 105 broadcast-transmits a beacon request by using the channel 5. Then, the receiving unit 106 receives beacons from control devices 20b, 20c, etc. which are operating by the channel 5. When the receiving unit 106 receives the beacons, the frame analysis unit 107 retrieves a network ID and a device address from each of the beacons. The retrieved network IDs and device addresses are stored into the control device list in association with the channel 5 (Step S152).

Next, when a scan timer for the channel 5 is expired (Step S153), then the channel selection unit 103 selects, as a frequency channel to be used to transmit a beacon request, a channel 6 (CH6) immediately subsequent to the channel 5 (CH5) (Step S154). In this state, the transmission unit 105 broadcast-transmits a beacon request by using the channel 6. Then, the receiving unit 106 receives beacons from control devices 20n, etc. which are operating by the channel 6. When the receiving unit 106 receives the beacons, a network ID and a device address are retrieved from each of the beacons and stored in the control device list in association with the channel 6 in the same manner as described above (Step S155). Here, in FIG. 7, the control device list becomes full and the scanning is ended (Step S156).

Here, if the control device list does not include the home control device, a user performs an operation for registration processing again. The detection unit 101 detects a control signal instructing start of registration processing, and scanning starts again.

Therefore, the channel selection unit 103 selects again one of the frequency channels at random as the first frequency channel to be used in transmission of a beacon request. Here, the channel 3 (CH3) is selected (Step S157). In this state, the transmission unit 105 broadcast-transmits a beacon request by using the channel 3. Then, the receiving unit 106 receives beacons from control devices 20a, etc. which are operating by the channel 3. When the receiving unit 106 receives the beacons, a network ID and a device address are retrieved from each of the beacons and stored in the control device list in association with the channel 3 in the same manner as described above (Step S1.58). Subsequently, the same processing is repeated. It should be noted in the example illustrated in FIG. 7 that the control device 20a operating by the channel 3 is the home control device, and the registration control unit 109 performs control to transmit, to the control device 20a by the channel 3, a registration request for requesting the control device 20a to register the communication terminal device 100 as a target to be controlled.

As described above, in the present embodiment, when the detection unit 101 detects such a control signal, the channel selection unit 103 selects one of the frequency channels at random as the first frequency channel to be used in beacon request transmission. Therefore, even if there are a large number of control devices in neighboring networks and a large number of beacons are received, it is possible, without a large-capacity memory, to find out the home control device and cause the home control device to register the communication terminal device 100 as a target to be controlled. Furthermore, even if, for example, the first attempt for the registration processing fails to find the home control device, it is possible to increase a probability of finding the home control device and causing the home control device to register the communication terminal device as the number of attempts for the registration processing is increased.

It should also be noted that it has been described in the present embodiment that, if the control device list includes the home control device, the registration control unit 109 transmits a registration request to the control device, or even if it is not certain whether or not the control device list includes the home control device, the registration control unit 109 transmits a registration request sequentially to all the control devices. However, the present invention is not limited to the above.

For example, it is also possible that the communication terminal device 100 includes a sensor unit (not shown) that detects a receiving electrical field intensity of a beacon received by the receiving unit 106, and stores the receiving electrical field intensity detected by the sensor unit as well as the network ID, the device address, the frequency channel, and the like into the control device list. Then, after completion of the scanning, a registration request signal is transmitted to a control device identified by a network ID having the highest receiving electrical field intensity in the control device list.

Thereby, even if, for example, a beacon does not include information for determining whether or not a corresponding control device is the home control device, it is possible to cause the home control device to register the communication terminal device 100 as a target to be controlled.

Furthermore, it is also possible to transmit a registration request signal not only to the control device identified by the network ID having the highest receiving electrical field intensity, but also to a control device or the like which is identified by a network ID having the second highest receiving electrical field intensity.

It should be noted that it has been described in the present embodiment that, at Step S109 in FIG. 6, a frequency channel immediately subsequent to a current frequency channel is selected, but the present invention is not limited to the above. For example, it is possible to select a frequency channel at random from frequency channels which have not yet been used in scanning. Therefore, the randomness of the frequency channel selection is increased, thereby increasing a probability of finding the home control device and registering the target communication terminal device.

### Embodiment 2

In Embodiment 1, the first frequency channel to be used in transmission of a beacon request is selected at random from a plurality of frequency channels every time a control signal is detected. In contrast, in Embodiment 2, the first frequency channel to be used in transmission of a beacon request is selected at random from a plurality of frequency channels when a control signal is detected for the first time, but a frequency channel immediately subsequent to the latest frequency channel that has been previously used is selected when a control signal is detected for the second or successive time.

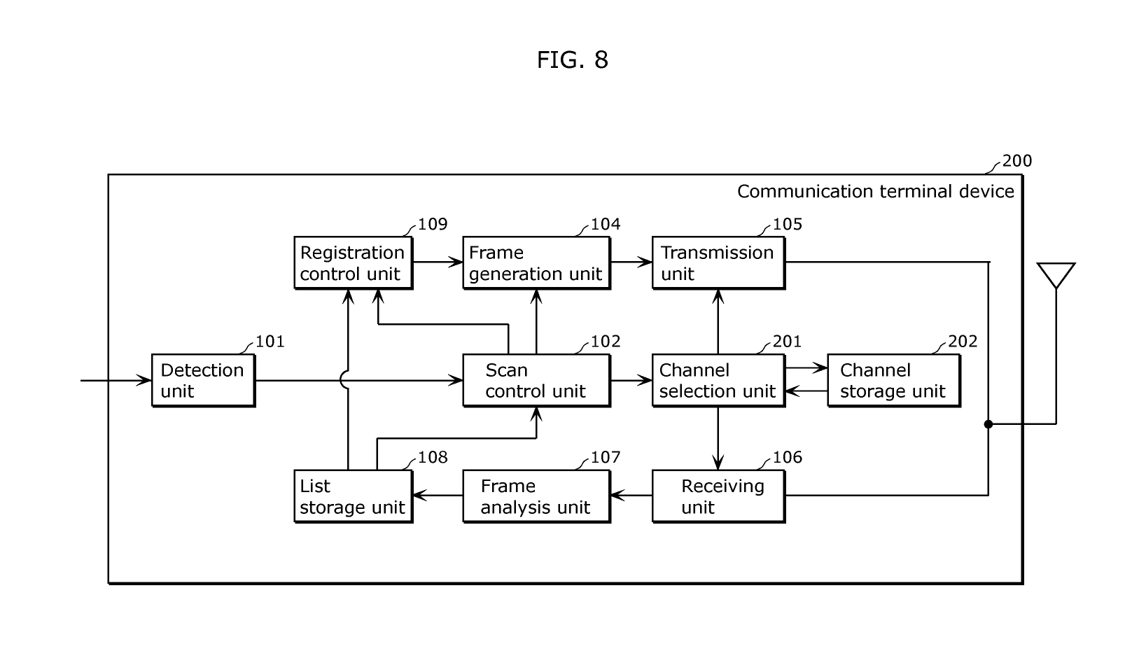

FIG. 8 is a block diagram illustrating a structure of a communication terminal device according to Embodiment 2. The same reference numerals in the Embodiment 1 are assigned to the identical elements in Embodiment 2, so that the identical elements are not described again.

The communication terminal device 200 is a device that causes a control device to register the communication terminal device 200 as a target to be controlled. As illustrated in FIG. 8, the communication terminal device 200 includes the detection unit 101, the scan control unit 102, a channel selection unit 201, the frame generation unit 104, the transmission unit 105, the receiving unit 106, the frame analysis unit 107, the list storage unit 108, the registration control unit 109, and a channel storage unit 202.

When the detection unit 101 detects a control signal for the first time, the channel selection unit 201 selects one of the frequency channels at random as the first frequency channel to be used in beacon request transmission.

When the scanning by the current frequency channel is completed, the channel selection unit 201 then selects a subsequent frequency channel (for example, selects a channel 4 if the current frequency channel is a channel 3). In this manner, the channel selection unit 201 selects the channels sequentially one by one.

The channel selection unit 201 stores the current frequency channel into the channel storage unit 202.

Then, when the detection unit 101 detects a control signal for the second or successive time, the channel selection unit 201 selects, as the first frequency channel to be used in beacon request transmission, a frequency channel immediately subsequent to the frequency channel stored in the channel storage unit 202.

The channel storage unit 202 is an example of the second storage unit according to the aspect of the present invention. The channel storage unit 202 stores a frequency channel that is currently used.

Next, processing performed by the communication terminal device 200 having the above-described structure is described.

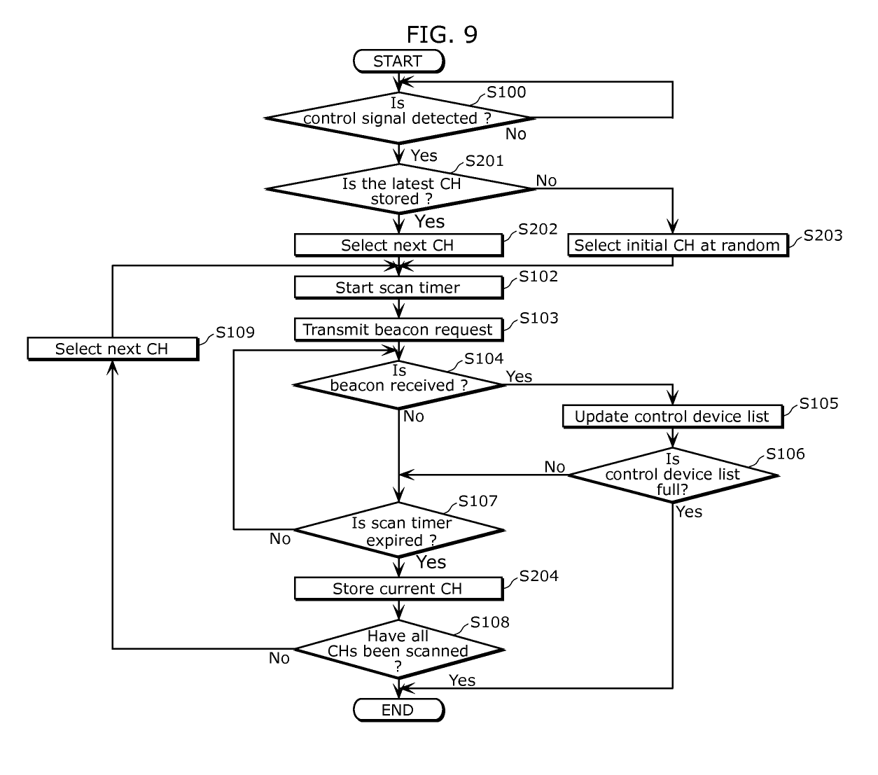

FIG. 9 is a flowchart of the scanning performed by the communication terminal device 200 according to Embodiment 2. The same step numbers in Embodiment 1 are assigned to the identical steps in Embodiment 2.

When the detection unit 101 detects a control signal instructing start of registration processing (Yes at Step S100), the channel selection unit 201 determines whether or not the channel storage unit 202 stores the latest frequency channel that has been previously used (Step S201).

If it is determined that the latest frequency channel is stored (Yes at Step S201), in other words, if the detection unit 101 detects a control signal for the second or successive time, the channel selection unit 201 selects, as the first frequency channel to be channel used in beacon request transmission, a frequency channel immediately subsequent to the latest frequency channel stored in the channel storage unit 202 (Step S202).

On the other hand, if the latest frequency channel is not stored (No at Step S201), in other words, if the detection unit 101 detects a control signal for the first time, the channel selection unit 201 selects one of the frequency channels at random as the first frequency channel to be used in beacon request transmission (Step S203).

Next, the scan control unit 102 starts a scan timer for which a scan time period is previously set (Step S102). The scan control unit 102 performs control to broadcast-transmit a beacon request (Step S103). More specifically, the scan control unit 102 instructs the frame generation unit 104 and the transmission unit 105 to broadcast-transmit a beacon request by using the frequency channel selected by the channel selection unit 201.

The scan control unit 102 determines whether or not the receiving unit 106 receives a beacon (Step S104). If it is determined that a beacon is received (Yes at Step S104), then the frame analysis unit 107 analyzes the beacon received by the receiving unit 106, then retrieves, from the beacon, predetermined parameters, such as a network ID and a device address which are used for identifying the control device having transmitted the beacon, and stores the parameters into the list storage unit 108 in association with the frequency channel as the control device list (updates the control device list) (Step S105).

Next, the scan control unit 102 determines whether or not the control device list stored in the list storage unit 108 is full (Step S106). If it is determined that the control device list is full (Yes at Step S106), then the scan control unit 102 ends the scanning.

On the other hand, if the control device list is not full (No at Step S106) and if any beacon is not received (No at Step S104), then the scan control unit 102 determines whether or not the scan timer is expired (Step S107).

If it is determined that the scan timer is not expired (No at Step S107), then the processing returns to the step for the beacon receipt determination (Step S104). On the other hand, if the scan timer is expired (Yes at Step S107), then the channel selection unit 201 stores the current frequency channel into the channel storage unit 202 (Step S204).

Next, the scan control unit 102 determines whether or not the scanning has been performed by all the frequency channels (Step S108). If it is determined that scanning has not yet been performed by using all the frequency channels (No at Step S108), then the channel selection unit 201 selects a subsequent frequency channel (for example, selects a channel 4 if the current frequency channel is a channel 3) (Step S109) and the processing returns to the step for the scan timer start (Step S102) and repeats the subsequent steps. If scanning has already been performed by using all the frequency channels (Yes at Step S108), then the scan control unit 102 ends the scanning.

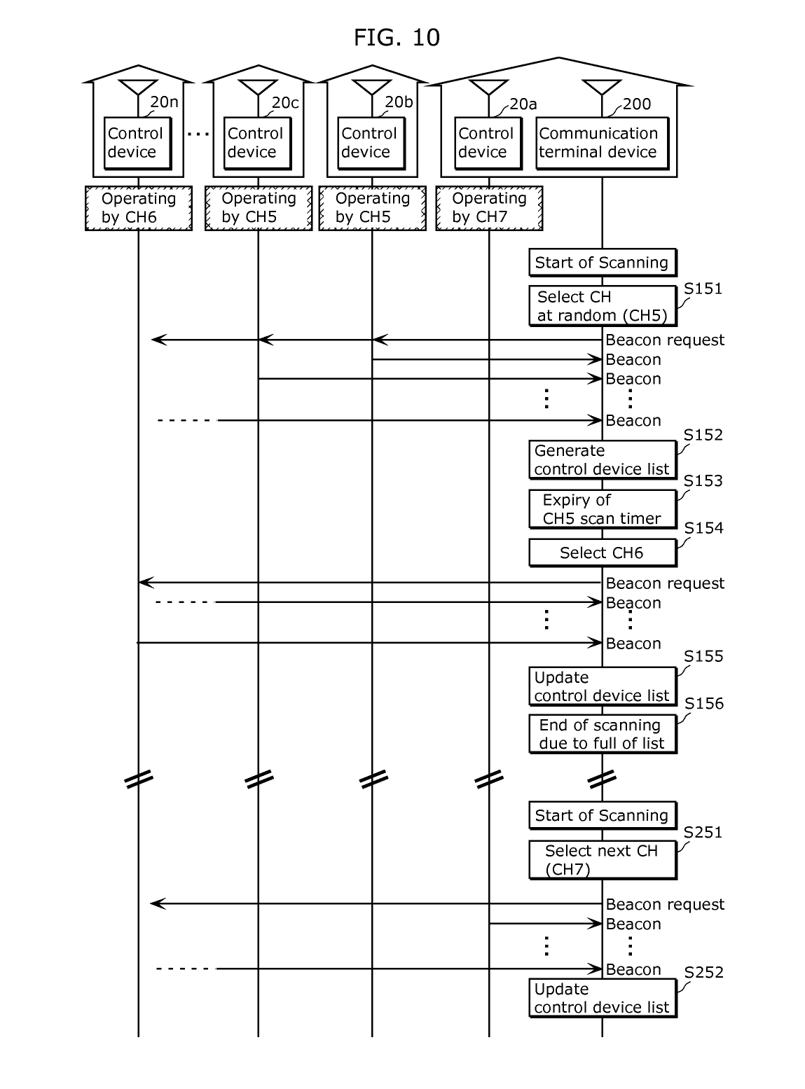

FIG. 10 is a sequence diagram of an example of detailed steps in the scanning according to Embodiment 2. It should be noted that, for the sake of simplicity in the explanation, the sequence diagram of FIG. 10 does not include all of the steps in the flowchart of FIG. 9.

Referring to FIG. 10, when the detection unit 101 detects a control signal instructing start of registration processing for the first time, scanning starts. Then, since a control signal is detected for the first time, the channel selection unit 201 performs the step for the random frequency channel selection (Step S151), and then the subsequent steps until the control device list becomes full and therefore the scanning is ended (Step S156) are the same as those in the example of FIG. 7.

Here, if the control device list does not include the home control device, a user performs an operation for registration processing again. The detection unit 101 detects a control signal instructing start of registration processing, and scanning starts again.

Here, the channel selection unit 201 re-selects, as the first frequency channel to be used in beacon request transmission, a frequency channel immediately subsequent to the frequency channel (in this example, CH6) stored in the channel storage unit 202. In this example, a channel 7 (CH7) is selected (Step S251).

In this state, the transmission unit 105 broadcast-transmits a beacon request by using the channel 7. Then, the receiving unit 106 receives beacons from control devices 20a, etc. which are operating by the channel 7.

When the receiving unit 106 receives the beacons, a network ID and a device address are retrieved from each of the beacons and stored in the control device list in association with the channel 7 in the same manner as described above (Step S252).

Subsequently, the same processing is repeated. It should be noted in the example illustrated in FIG. 10 that the control device 20a operating by the channel 7 is the home control device, and the registration control unit 109 performs control to transmit, to the control device 20a by the channel 7, a registration request for requesting the control device 20a to register the communication terminal device 200 as a target to be controlled.

As described above, according to the present embodiment, when detection unit 101 detects a control signal for the first time, the channel selection unit 201 selects one of the frequency channels at random as the first frequency channel to be used in beacon request transmission, and when the detection unit 101 detects a control signal for the second or successive time, the channel selection unit 201 selects a frequency channel immediately subsequent to the latest frequency channel that has been previously used.

Therefore, even if there are a large number of control devices in neighboring networks and a large number of beacons are received, it is possible, without a large-capacity memory, to find out the home control device and cause the home control device to register the communication terminal device as a target to be controlled.

Furthermore, even if, for example, the first attempt for the registration processing fails to find the home control device, it is possible to increase a probability of finding the home control device and causing the home control device to register the communication terminal device as the number of attempts for the registration processing is increased.

It should be noted that it has been described in the present embodiment that, when the detection unit 101 detects a control signal for the second or successive time, the channel selection unit 201 selects, as the first frequency channel to be used in beacon request transmission, a frequency channel immediately subsequent to a frequency channel stored in the channel storage unit 202. However, the present invention is not limited to the above.

For example, it is also possible that, when the detection unit 101 detects a control signal for the second or successive time, the channel selection unit 201 selects the frequency channel stored in the channel storage unit 202, as the first frequency channel to be used in beacon request transmission.

It is therefore possible to search again, from the beginning, for a control device which has not been received by the frequency channel stored in the channel storage unit 202 due to full of the receiving buffer. As a result, a probability of causing the home control device to resister the target communication terminal device is increased in the second and successive attempts for the registration processing.

### Embodiment 3

In Embodiment 3, every time a control signal is detected, one of frequency channels is selected at random as the first frequency channel to be used in beacon request transmission in the same manner as described in Embodiment 1, and transmission power for the beacon request transmission is increased.

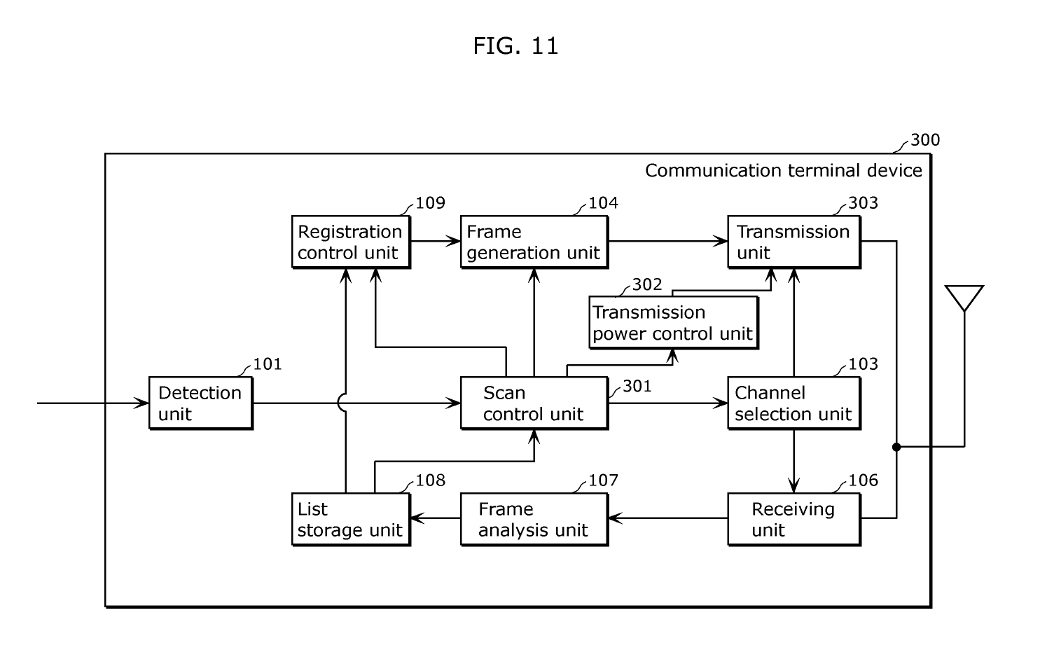

FIG. 11 is a block diagram illustrating a structure of a communication terminal device according to Embodiment 3. The same reference numerals in the Embodiment 1 are assigned to the identical elements in Embodiment 3, so that the identical elements are not described again.

The communication terminal device 300 is a device that causes a control device to register the communication terminal device 300 as a target to be controlled. As illustrated in FIG. 11, the communication terminal device 300 includes the detection unit 101, a scan control unit 301, the channel selection unit 103, the frame generation unit 104, a transmission unit 303, the receiving unit 106, the frame analysis unit 107, the list storage unit 108, the registration control unit 109, and a transmission power control unit 302.

The scan control unit 301 performs scanning to search for the home control device. More specifically, the scan control unit 301 performs control to broadcast-transmit a beacon request for requesting control devices to transmit beacons. The scanning allows the communication terminal device to search a plurality of control devices including control devices in nearby networks such as networks in neighbors, for a desired control device to be connected (home control device).

Furthermore, the scan control unit 301 performs control to broadcast-transmit a beacon request by all a plurality of frequency channels. Under the control, a beacon request is broadcast-transmitted (simultaneously transmitted) first by using one of the frequency channels. Here, when a predetermined scan time period has passed (expiry of a scan timer), the scan control unit 301 ends the scanning by the current frequency channel and starts broadcast-transmission of a beacon request by using a different frequency channel.

Furthermore, when broadcast-transmission of a beacon request is to start or when broadcast-transmission of a beacon request is ended, the scan control unit 301 notifies the start or end to the transmission power control unit 302.

When the transmission power control unit 302 receives, from the scan control unit 301, notification indicating that broadcast-transmission of a beacon request is to start, the transmission power control unit 302 lowers a predetermined transmission power level of the transmission unit 303 to, for example, a half. Furthermore, when the transmission power control unit 302 receives, from the scan control unit 301, notification indicating that broadcast-transmission of a beacon request is ended, the transmission power control unit 302 sets the lowered transmission power level of the transmission unit 303 back to the predetermined transmission power level.

The transmission unit 303 broadcast-transmits, with the transmission power level controlled and lowered by the transmission power control unit 302, a frame of a beacon request generated by the frame generation unit 104 by using a frequency channel selected by the channel selection unit 103.

Next, processing performed by the communication terminal device 300 having the above-described structure is described.

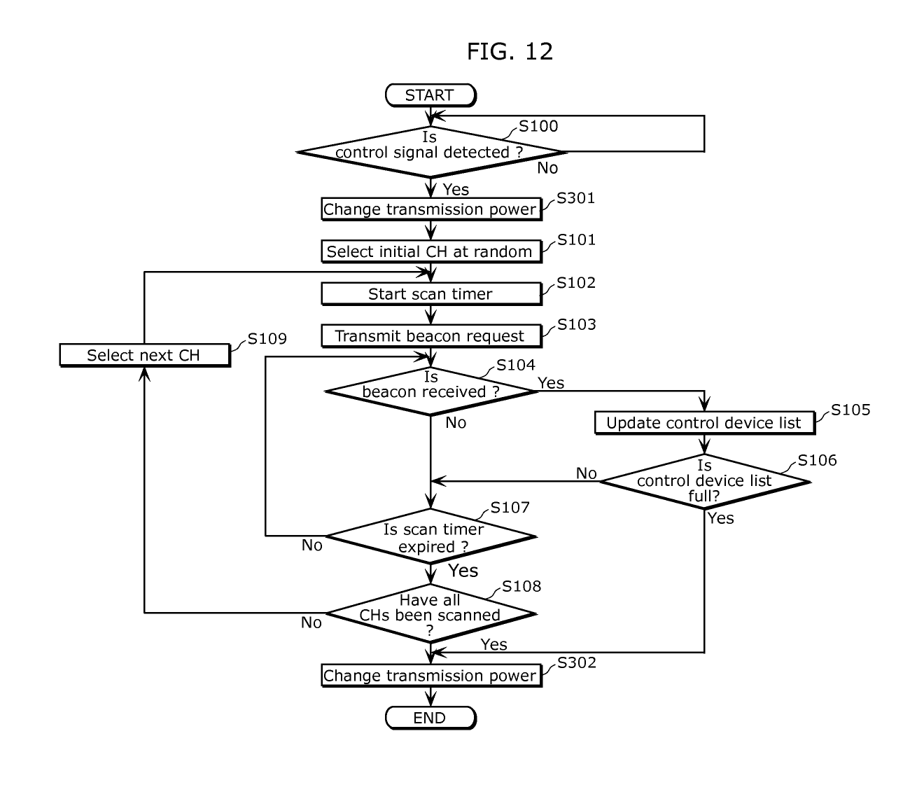

FIG. 12 is a flowchart of the scanning performed by the communication terminal device 300 according to Embodiment 3. The same step numbers in Embodiment 1 are assigned to the identical steps in Embodiment 3.

When the detection unit 101 detects a control signal instructing start of registration processing (Yes at Step S100), the transmission power control unit 302 receives, from the scan control unit 301, a notification indicating that a beacon request is to be broadcast-transmitted, and then lowers a predetermined transmission power level of the transmission unit 303 (Step S301).

Next, the channel selection unit 103 selects one of frequency channels at random as the first frequency channel to be used in the beacon request transmission (Step S101). The scan control unit 301 starts a scan timer for which a scan time period is previously set (Step S102). The scan control unit 301 performs control to broadcast-transmit a beacon request (Step S103).

More specifically, the scan control unit 301 instructs the frame generation unit 104 and the transmission unit 303 to broadcast-transmit a beacon request by using the frequency channel selected by the channel selection unit 103. Here, the transmission power level of the transmission unit 303 is lowered from the predetermined transmission power level, the beacon request is broadcast-transmitted with the lowered transmission power level.

The scan control unit 301 determines whether or not the receiving unit 106 receives a beacon (Step S104). If it is determined that a beacon is received (Yes at Step S104), then the frame analysis unit 107 analyzes the beacon received by the receiving unit 106, then retrieves, from the beacon, predetermined parameters, such as a network ID and a device address which are used for identifying the control device having transmitted the beacon, and stores the predetermined parameters into the list storage unit 108 in association with the frequency channel as the control device list (updates the control device list) (Step S105).

Next, the scan control unit 301 determines whether or not the control device list stored in the list storage unit 108 is full (Step S106). If it is determined that the control device list is full (Yes at Step S106), then the scan control unit 301 terminates the scanning, and the transmission power control unit 302 sets the lowered transmission power level of the transmission unit 303 back to the predetermined transmission power level (Step S302).

On the other hand, if the control device list is not full (No at Step S106) or if any beacon is not received (No at Step S104), then the scan control unit 301 determines whether or not the scan timer is expired (Step S107).

If it is determined that the scan timer is not expired (No at Step S107), then the processing returns to the step for the beacon receipt determination (Step S104). On the other hand, if the scan timer is expired (Yes at Step S107), then the scan control unit 301 determines whether or not scanning has been performed by using all the frequency channels (Step S108).

If it is determined that scanning has not yet been performed by using all the frequency channels (No at Step S108), then the channel selection unit 103 selects a subsequent frequency channel (for example, selects a channel 4 if the current frequency channel is a channel 3) (Step S109) and the processing returns to the step for the scan timer start (Step S102) and repeats the subsequent steps.

If scanning has already been performed by using all the frequency channels (Yes at Step S1.08), then the scan control unit 301 ends the scanning, and the transmission power control unit 302 sets the lowered transmission power level of the transmission unit 303 back to the predetermined transmission power level (Step S302).

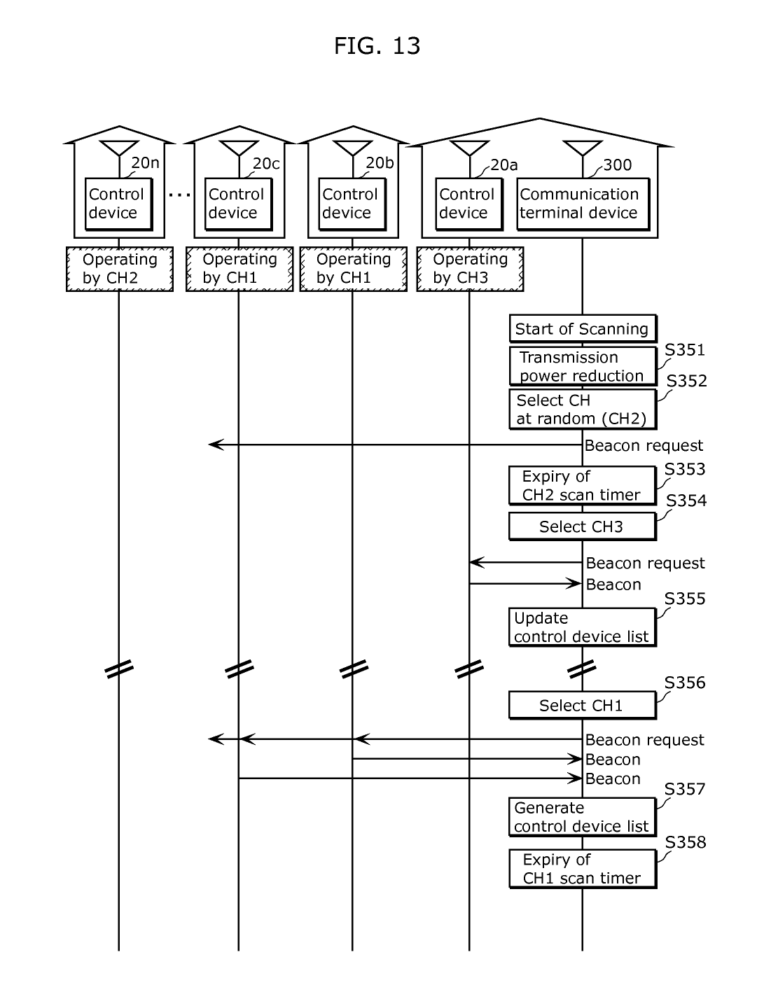

FIG. 13 is a sequence diagram of an example of detailed steps in the scanning according to Embodiment 3. It should be noted that, for the sake of simplicity in the explanation, the sequence diagram of FIG. 13 does not include all of the steps in the flowchart of FIG. 12.

Referring to FIG. 13, when the detection unit 101 detects a control signal instructing start of registration processing, scanning starts. Then, the transmission power control unit 302 lowers the predetermined transmission power level of the transmission unit 303 (Step S351).

Then, the channel selection unit 103 selects one of frequency channels at random as the first frequency channel to be used in beacon request transmission. In this example, a channel 2 (CH2) is selected (Step S352).

In this state, the transmission unit 303 broadcast-transmits a beacon request by using the channel 2. Here, the transmission power level of the transmission unit 303 is lowered from the predetermined transmission power level, the beacon request is broadcast-transmitted with the lowered transmission power level. Therefore, a propagation area of the beacon request is reduced. In FIG. 13, in the propagation area of the beacon request, there is not a control device operating by the channel 2 and a beacon is not received.

Next, when a scan timer for the channel 2 is expired (Step S353), then the channel selection unit 103 selects, as a frequency channel to be used to transmit a beacon request, a channel 3 (CH3) immediately subsequent to the channel 2 (CH2) (Step S354). In this state, the transmission unit 303 broadcast-transmits a beacon request by using the channel 3. Then, the receiving unit 106 receives beacons from control devices 20a, etc. which are operating by the channel 3. When the receiving unit 106 receives the beacons, a network ID and a device address are retrieved from each of the beacons and stored in the control device list in association with the channel 3 in the same manner as described above (Step S355).

Here, if a total number of the frequency channels is, for example, eight channels, then the channel selection unit 103 sequentially selects channels 4 to 8 and repeats the same processing by each channel. Finally, the channel selection unit 103 selects, as a frequency channel to be used in beacon request transmission, a channel 1 (CH1) immediately subsequent to the channel 8 (CH8) (Step S356).

In this state, a beacon request is broadcast-transmitted by using the channel 1. Then, beacons are received from the control devices 20b and 20c which are operating by the channel 1. When the beacons are received, a network ID and a device address are retrieved from each of the beacons and stored in the control device list in association with the channel 1 in the same manner as described above (Step S357). Then, when a scan timer for the channel 1 is expired (Step S358), the scanning has been completed.

It should be noted in the example illustrated in FIG. 13 that the control device 20a operating by the channel 3 is the home control device, and the registration control unit 109 performs control to transmit, to the control device 20a by the channel 1, a registration request for requesting the control device 20a to register the communication terminal device 300 as a target to be controlled.

As described above, in the present embodiment, when a beacon request is to be broadcast-transmitted, the transmission power control unit 302 lowers the predetermined transmission power level of the transmission unit 303. Therefore, a propagation area of the beacon request is reduced. As a result, even if there are a large number of control devices in neighboring networks in an original propagation area of the beacon request signal, it is possible, without a large-capacity memory, to find the home control device and cause the home control device to register the communication terminal device as a target to be controlled. Furthermore, even if, for example, the first attempt for the registration processing fails to find the home control device, it is possible to increase a probability of finding the home control device and causing the home control device to register the communication terminal device as the number of attempts for the registration processing is increased.

It should be noted that, in each of the above-described embodiments, the transmission unit or the receiving unit may perform not only wireless communication, but also wired communication, such as Power Line Communication (PLC), Ethernet®, Universal Serial Bus (USB), and High-Definition Multimedia Interface® (HDMI). With the communication methods, the communication terminal device according to the present invention can perform communication by various transmission mediums.

It should also be noted that it has been described in the above embodiments that the communication terminal device transmits a beacon request and receives a beacon from a control device according to IEEE802.15.4 standard, but the present invention is not limited to the above. For example, it is also possible to perform scanning according to IEEE802.11 standard, so that the communication terminal device transmits a probe request and receives a probe response from a control device. The communication terminal device according to the present invention can provide the same effects also by probe transmission and probe response.

It should also be noted that, in each of the above-described embodiment, each of the structural elements may be implemented to a dedicated hardware or executed by a suitable software program. Each of the structural elements may be implemented by reading a software program by a program execution unit, such as a Central Processing Unit (CPU) or a processor, from a recording medium such as a hard disk or a semiconductor memory, and executing the software program. An example of the software for implementing the communication terminal device in each of the above-described embodiments is a program as described below.

The program causes a computer to execute a control method of controlling a communication terminal device. The method including: detecting a control signal instructing start of registration processing for causing a desired control device among a plurality of control devices to register a communication terminal device as a target to be controlled; sequentially selecting, from a plurality of frequency channels, a frequency channel to be used in transmission of a beacon request for requesting each of the control devices to transmit a beacon signal; transmitting the beacon request to each of the control devices by using the frequency channel selected in the selecting; and receiving the beacon signal from each of the control devices in response to the beacon request, wherein in the selecting, a first frequency channel to be used in transmission of the beacon request is selected at random from the frequency channels, when the control signal is detected in the detecting.

Although the communication terminal devices according to one or more aspects of the present invention have been described based on the above embodiments, the present invention is not limited to them. Those skilled in the art will be readily appreciate that various modifications and combinations of the structural elements in the embodiments are possible without materially departing from the novel teachings and advantages of the present invention. Accordingly, all such modifications and combinations are intended to be included within the scope of the present invention.

### INDUSTRIAL APPLICABILITY

The present invention is capable of searching for a home control device and causing the home control device to register a target communication terminal device to be controlled without providing a large-capacity memory. The present invention is useful for a communication terminal device or the like which causes a control device to register the communication terminal device as a target to be controlled via a wired communication network or a wireless communication network.

### REFERENCE SIGNS LIST

10, 100, 200, 300 communication terminal device
20 control device
101 detection unit
102, 301 scan control unit
103, 201 channel selection unit
104 frame generation unit
105, 303 transmission unit
106 receiving unit
107 frame analysis unit
108 list storage unit
109 registration control unit
202 channel storage unit
302 transmission power control unit

1. A communication terminal device comprising:
a wireless communication unit configured to wirelessly communicate with control devices;
a detection unit configured to detect a control signal instructing start of registration processing for causing a desired control device among the control devices to register the communication terminal device as a target to be controlled;
a channel selection unit configured to sequentially select, from a plurality of frequency channels, a frequency channel to be used in transmission of a beacon request for requesting each of the control devices to transmit a beacon signal;
a first transmission control unit configured to transmit, via the wireless communication unit, the beacon request to the control devices by using the frequency channel selected by the channel selection unit; and
a receiving unit configured to receive, via the wireless communication unit, the beacon signal transmitted from each of the control devices in response to the beacon request,
wherein the channel selection unit is configured to select at random a first frequency channel to be used in transmission of the beacon request from the frequency channels, when the detection unit detects the control signal.

2. The communication terminal device according to claim 1, further comprising:
a first storage unit configured to store (a) a predetermined parameter included in the beacon signal received by the receiving unit and (b) the frequency channel selected by the channel selection unit in association with each other; and
a second transmission control unit configured to transmit a registration request to the desired control device specified by the predetermined parameter by the frequency channel associated with the predetermined parameter, the registration request being for requesting the desired control device to register the communication terminal device as the target to be controlled,
wherein the receiving unit is configured to further receive a registration response signal transmitted from the desired control device in response to the registration request, the registration response signal indicating that the desired control device has completed the registration of the communication terminal device or that the desired control device rejects the registration.

3. The communication terminal device according to claim 1,
wherein the channel selection unit is configured to select at random a first frequency channel to be used in re-transmission of the beacon request, when the detection unit re-detects the control signal.

4. The communication terminal device according to claim 1, further comprising
a second storage unit configured to store information indicating a frequency channel that is currently used to transmit the beacon request,
wherein the channel selection unit is configured to, when the detection unit re-detects the control signal, determine, as a first frequency channel to be used in re-transmission of the beacon request, one of (a) the frequency channel stored in the second storage unit and (b) a subsequent frequency channel.

5. The communication terminal device according to claim 2, further comprising
a sensor unit configured to detect a receiving electrical field intensity of the beacon signal received by the receiving unit,
wherein the first storage unit is configured to, for each of the control devices, store the receiving electrical field intensity detected by the sensor unit in addition to the predetermined parameter and the frequency channel in association with one another, and
the second transmission control unit is configured to transmit the registration request to the desired control device specified by the predetermined parameter in a group including a highest receiving electrical field intensity among at least one group in which the predetermined parameter, the frequency channel, and the receiving electrical field intensity are associated with one another in the first storage unit.

6. The communication terminal device according to claim 1, further comprising
a transmission power control unit configured to lower a transmission power level from a predetermined transmission power level, when the first transmission control unit is to transmit the beacon request.

7. The communication terminal device according to claim 6,
wherein the transmission power control unit is configured to, when the first transmission control unit completes the transmission of the beacon request, set the transmission power level lowered for the transmission of the beacon request back to the predetermined transmission power level.

8. The communication terminal device according to claim 1,
wherein the communication terminal device is one of a home appliance and an energy-related device each of which has a communication function.

9. The communication terminal device according to claim 1,
wherein the beacon signal is a beacon frame compliant with IEEE802.15.4 standard, and
the beacon request is a beacon request frame compliant with the IEEE802.15.4 standard.

10. The communication terminal device according to claim 1,
wherein the beacon signal is a probe response frame compliant with IEEE802.11 standard, and
the beacon request is a probe request frame compliant with the IEEE802.11 standard.

11. A communication system comprising:
the communication terminal device according to claim 1; and
a control device that transmits the beacon signal in response to the beacon request transmitted from the communication terminal device, and registers the communication terminal device as the target to be controlled in response to the registration request transmitted from the communication terminal device.

12. A control method of controlling a communication terminal device, the method comprising:
detecting a control signal instructing start of registration processing for causing a desired control device among a plurality of control devices to register a communication terminal device as a target to be controlled;
sequentially selecting, from a plurality of frequency channels, a frequency channel to be used in transmission of a beacon request for requesting each of the control devices to transmit a beacon signal;
transmitting the beacon request to each of the control devices by using the frequency channel selected in the selecting; and
receiving the beacon signal from each of the control devices in response to the beacon request,
wherein in the selecting, a first frequency channel to be used in transmission of the beacon request is selected at random from the frequency channels, when the control signal is detected in the detecting.
